(19) United States
(12) Patent Application Publication
(10) Pub. No.: US 2007/0052668 A1
(43) Pub. Date: Mar. 8, 2007

(54) Electrophoretic display panel

(75) Inventors: Guofu Zhou, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/574,450

(22) PCT Filed: Oct. 5, 2004
(86) PCT No.: PCT/IB04/51972

§ 371 Date: Apr. 4, 2006

(30) Foreign Application Priority Data
Oct. 7, 2003 (EP) 03103701.3

(51) Int. Cl. G09G 3/34

(52) U.S. Cl. 345/107

(57) ABSTRACT

The electrophoretic display panel (1) for subsequently displaying pictures has a plurality of picture elements (2) and drive means (100). The drive means (100) are able to supply to each picture element (2) a picture pulse. Each picture pulse is a sequence of potential difference pulses and has a response-increasing pulse for increasing the ability of the particles (6) to respond to the potential difference without substantially changing the position of the particles (6), and a drive pulse for bringing the particles (6) into one of the positions for displaying the respective picture. For the display panel (1) to be able to have reduced image retention, less disturbing visual effects than in a method using reset pulses, and a shorter picture update time than in a method using short pulses, with respect to at least a number of the picture elements (2), for each picture element (2) out of said number the display panel (100) further comprises averaging means (200) for providing information with respect to an accumulation of charge in the picture element (2), which accumulation of charge is a result from picture pulses preceding the response-increasing pulse, and the drive means (100) being further arranged to select, based on the information, a time average of the response-increasing pulse to reduce an undesired charge accumulation in the picture element (2).

The invention relates to an electrophoretic display panel for subsequently displaying pictures comprising
a plurality of picture elements, each picture element comprising two electrodes for receiving a potential difference and charged particles being able to occupy positions between the electrodes, and
drive means being able to supply to each picture element a picture pulse, each picture pulse being a sequence of potential difference pulses and comprising
   a response-increasing pulse for increasing the ability of the particles to respond to the potential difference without substantially changing the position of the particles, and
   a drive pulse for bringing the particles into one of the positions for displaying the respective picture.

An embodiment of the electrophoretic display panel of the type mentioned in the opening paragraph is described in non-prepublished European Patent application 02077017.8.

Electrophoretic display panels in general are based on the motion of charged, usually colored particles under the influence of an electric field between electrodes. With these display panels, dark or colored characters can be imaged on a light or colored background, and vice versa. Electrophoretic display panels are therefore notably used in display devices taking over the function of paper, referred to as “paper white” applications, e.g. electronic newspapers and electronic diaries. The picture elements have, during the display of the picture, appearances determined by the positions of the charged particles between the electrodes.

The described electrophoretic display panel shows response-increasing pulses consisting of a series of e.g. 12 pulses having potential difference values of alternating polarity of plus and minus 15 Volts with each pulse having a duration of 20 ms. Subsequently, the drive pulse, for instance having a potential difference value of 15 Volts and a duration of 100 ms, brings the particles into one of the positions for displaying the picture.

Insulating layers are present between the electrodes, which become charged as a result of the potential differences. This built up of remnant dc voltages caused by changing the appearances of the picture elements between subsequent pictures, especially after integration of multiple changes in appearances, may result in severe image retention and shorten the life of the display panel.

Known methods of reducing image retention use reset pulses supplied to all picture elements during the picture update. The reset pulses have the same polarity as the polarity of the preceding picture pulse and cause the image displayed to become completely white or black. Consequently, these reset pulses seriously diminish display performance because the display panel flashes between black and white.

Non pre-published European patent application PHNL030205EPP, which has been filed as European Patent Application 03100575.4, describes an arrangement in which short pulses are applied to each picture element after a picture update, the short pulses having a polarity which is opposite to the polarity of the preceding picture pulse and having an energy which is insufficient to substantially change the position of the particles. As a result the undesired charge accumulation in the picture element is reduced causing image retention to be reduced with less disturbing visual effects than in the above-mentioned method using reset pulses. However, the short pulses increase the picture update time.

It is an object of the invention to provide a display panel of the kind mentioned in the opening paragraph with reduced image retention, less disturbing visual effects than in the above-mentioned method using reset pulses, and a shorter picture update time than in the above-mentioned method using short pulses.

The object is thereby achieved that with respect to at least a number of the picture elements, for each picture element out of said number
the display panel further comprises averaging means for providing information with respect to an accumulation of charge in the picture element, which accumulation of charge is a result from picture pulses preceding the response-increasing pulse, and
the drive means are further arranged to select, based on the information, a time average of the response-increasing pulse to reduce an undesired charge accumulation in the picture element.

The time average of the response-increasing pulse of each picture element of said number results in a reduction the undesired charge accumulation in the picture element, thereby reducing image retention without an increase of the picture update time. Furthermore, the response-increasing pulse increases the ability of the particles to respond to the potential difference without substantially changing the position of the particles, thereby causing less disturbing visual effects than in the above-mentioned method using reset pulses.

In an embodiment
the response-increasing pulse has a response-increasing value and an associated response-increasing duration, the product of which represents a response-increasing energy,
the drive pulse has a drive value and an associated drive duration, the product of which represents a drive energy,
the averaging means are able to receive data representative of the response-increasing energy and the drive energy of the picture pulses preceding said response-increasing pulse, and provide a running total thereof, and
the drive means are further arranged to select the time average of the response-increasing pulse such that the magnitude of said running total is reduced.

In a variation on the embodiment
the averaging means are able to receive data representative of the response-increasing energy and the drive energy of the last picture pulse from the picture pulses preceding said response-increasing pulse, the running total being equal to the sum of the response-increasing energy and the drive energy of the last picture pulse, and
the drive means are further arranged to select
   a sign of the time average of the response-increasing pulse to be opposite to a sign of the running total, and
      the magnitude of the product of the response-increasing duration and the time average of the response-increasing pulse to be smaller or equal to the magnitude of the running total. Then the response-increasing pulse is able to undo at least a part of the charge of the insulators due to the last picture pulse. If, furthermore, the magnitude of the product of the response-increasing duration and the time average of the response-increasing pulse is substantially equal to the magnitude of the running total, the response-increasing pulse is able to substantially undo the charging of the insulators due to the last picture pulse. Then each picture element of said number can be DC stabilized every picture update.

In another variation on the embodiment the response-increasing pulse is the sum of an AC part, having an associated time average being substantially zero, and a DC part. Then the response-increasing pulses can relatively easy be generated by the drive means. If the DC part is equal to a constant, the DC part of the response-increasing pulse can very simply be generated. If a magnitude of the DC part is a decreasing function of time, the magnitude of the change of the position of the particles during the application of the response-increasing pulse is reduced, resulting in less disturbing visual effects. It is furthermore favorable, if the function is substantially linear. The driving scheme can relatively simply be implemented in the drive means, then.

If the AC part is a periodic function of time having a constant amplitude, the AC part of the response-increasing pulse can relatively easy be generated by the drive means. Examples are a sine or cosine function or a series of e.g. 10 pulses having potential difference values of alternating polarity of e.g. plus and minus 15 Volts with each pulse having a duration of e.g. 20 ms. If the AC part is a periodic function of time having a stepwise in time decreasing amplitude, the magnitude of the change of the position of the particles during the application of the response-increasing pulse is reduced, resulting in less disturbing visual effects. An example is e.g. a series of 6 pulses having potential difference values of 15, −15, 10, −10, 5 and −5 Volts with each pulse having a duration of 20 ms.

If the AC part is a series of pairs of sub-AC pulses, the two members of each pair having potential difference values of opposite polarity and substantially equal durations, the durations of the pairs in the series being a stepwise decreasing function of the serial number of the pairs in the series, the magnitude of the change of the position of the particles during the application of the response-increasing pulse is reduced, resulting in less disturbing visual effects. An example is e.g. a series of 6 pulses having potential difference values of 15, −15, 15, −15, 15 and −15 Volts with the pulses in the series having successive durations of 20, 20, 10, 10, 5, 5 ms.

It is favorable, if for each picture element out of said number the picture pulse comprises a reset pulse between the response-increasing pulse and the drive pulse, the reset pulse being able to bring the particles into one of extreme positions, the extreme positions being positions near the electrodes, the reset pulse representing an energy being at least as large as a reference energy representing an energy to change the position of particles from their present position to one of the extreme positions. Then, the dependency of the positions of the particles on a history of the potential differences is reduced, and the picture update is more accurate. It is preferred if, furthermore, the energy of each reset pulse is substantially larger than the reference energy. Then the picture update is even more accurate. Such reset potential differences are described in the non-prepublished European Patent application 03100133.2, having internal reference number PHNL030091. It is also preferred, if each reset pulse is able to bring the particles into the extreme position which is closest to the position of the particles for displaying the respective picture. Then an observer perceives a relatively smooth transition from an estimate of the picture to the picture. It is furthermore preferred, if for each picture element out of said number the picture pulse comprises a further response-increasing pulse between the reset pulse and the drive pulse. As a consequence of the further response-increasing pulse the picture update is even more accurate.

In another embodiment, the response-increasing pulses are synchronized in time.

In another embodiment, the display panel is an active matrix display panel.

It is favorable, it, in each aforementioned embodiment, each picture element is one of the number of the picture elements.

In an embodiment the display panel is part of a display device.

These and other aspects of the display panel of the invention will be additional elucidated and described with reference to the drawings, in which:

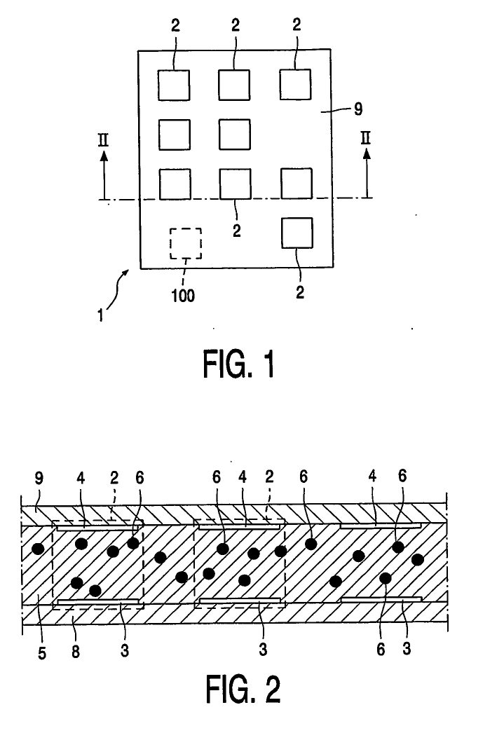

FIG. 1 shows diagrammatically a front view of an embodiment of the display panel;

FIG. 2 shows diagrammatically a cross-sectional view along II-II in FIG. 1;

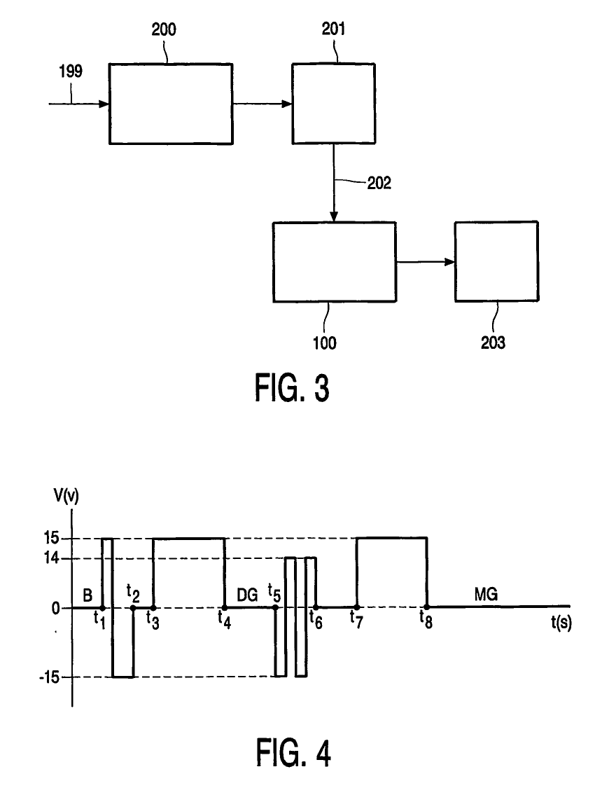

FIG. 3 shows a schematic block diagram of elements of an embodiment;

FIG. 4 shows diagrammatically picture pulses as a function of time for a picture element out of said number of picture elements in the embodiment;

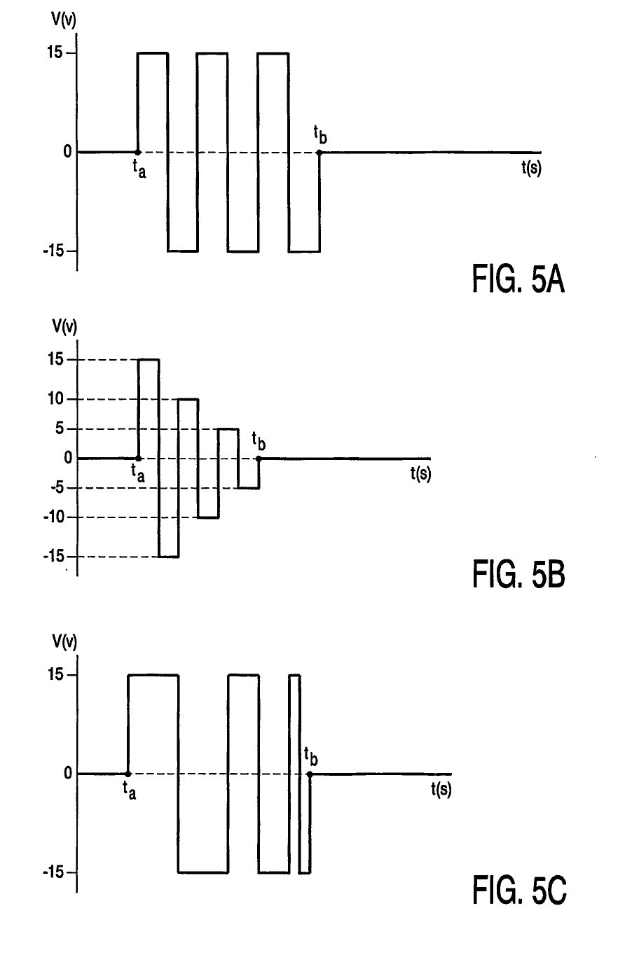

FIG. 5A shows diagrammatically an AC part as a function of time of the response-increasing pulse of a picture element out of said number of picture elements;

FIG. 5B shows diagrammatically another AC part as a function of time of the response-increasing pulse of a picture element out of said number of picture elements;

FIG. 5C shows diagrammatically another AC part as a function of time of the response-increasing pulse of a picture element out of said number of picture elements;

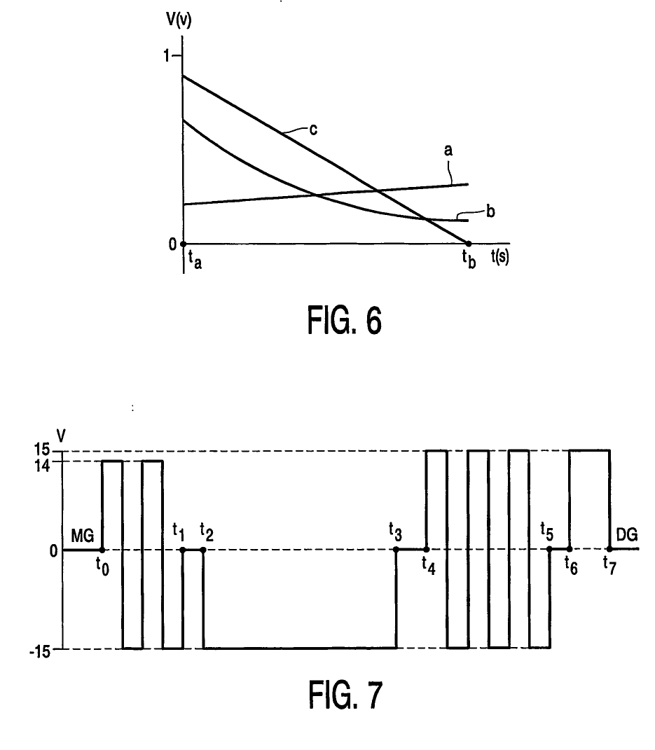

FIG. 6 shows diagrammatically three examples of DC parts as a function of time of the response-increasing pulse of a picture element out of said number of picture elements; and

FIG. 7 shows diagrammatically a picture pulse as a function of time for a picture element out of said number of picture elements in another embodiment.

In all the Figures corresponding parts are referenced to by the same reference numerals.

FIGS. 1 and 2 show an example of the display panel 1 having a first substrate 8, a second transparent opposed substrate 9 and a plurality of picture elements 2. Preferably, the picture elements 2 are arranged along substantially straight lines in a two-dimensional structure. Other arrangements of the picture elements 2 are alternatively possible, e.g. a honeycomb arrangement. In an active matrix embodiment, the picture elements 2 may further comprise switching electronics, for example, thin film transistors (TFTs), diodes, MIM devices or the like.

An electrophoretic medium 5, having charged particles 6 in a fluid, is present between the substrates 8,9. A first and a second electrode 3,4 are associated with each picture element 2 for receiving a potential difference. In FIG. 2 the first substrate 8 has for each picture element 2 a first electrode 3, and the second substrate 9 has for each picture element 2 a second electrode 4. The charged particles 6 are able to occupy a position being one of extreme positions near the electrodes 3,4 and intermediate positions in between the electrodes 3,4. Each picture element 2 has an appearance determined by the position of the charged particles 6 between the electrodes 3,4. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the picture element 2 is e.g. white. Here it is considered that the picture element 2 is observed from the side of the second substrate 9. When the charged particles 6 are in a second extreme position, i.e. near the second electrode 4, as a result of the potential difference being of opposite polarity, i.e. −15 Volts, the appearance of the picture element 2 is black. When the charged particles 6 are in one of the intermediate positions, i.e. in between the electrodes 3,4, the picture element 2 has one of the intermediate appearances, e.g. light gray, middle gray and dark gray, which are gray levels between white and black. The drive means 100 are able to supply to each picture element 2 a picture pulse. Each picture pulse is a sequence of potential difference pulses and comprises a response-increasing pulse for increasing the ability of the particles 6 to respond to the potential difference without substantially changing the position of the particles 6, and a drive pulse for bringing the particles 6 into one of the positions for displaying the respective picture. The response- changing pulse is e.g. a shaking pulse, which is a sequence of preset potential differences having preset values and associated preset durations. The preset values in the sequence alternate in sign and each preset potential difference represents a preset energy sufficient to release particles 6 present in one of the extreme positions from their position but insufficient to enable said particles 6 to reach the other one of the extreme positions. Furthermore, with respect to at least a number of the picture elements 2, for each picture element 2 out of said number the display panel 1 further comprises averaging means 200 for providing information with respect to an accumulation of charge in the picture element 2, which accumulation of charge is a result from picture pulses preceding the response-increasing pulse, and the drive means 100 are further arranged to select, based on the information, a time average of the response-increasing pulse to reduce an undesired charge accumulation in the picture element 6.

In an embodiment the response-increasing pulse has a response-increasing value and an associated response-increasing duration, the product of which represents a response-increasing energy, the drive pulse has a drive value and an associated drive duration, the product of which represents a drive energy, the averaging means 200 are able to receive data representative of the response-increasing energy and the drive energy of the picture pulses preceding said response-increasing pulse, and provide a running total thereof, and the drive means 100 are further arranged to select the time average of the response-increasing pulse such that the magnitude of said runing total is reduced. Referring to FIG. 3, a schematic block diagram of the embodiment is illustrated. The averaging means 200 receive data 199 representative of the response-increasing energy and the drive energy of the picture pulses preceding said response-increasing pulse, and provide a running total 201 thereof. The drive means 100 use the running total 201 to select the time average 203 of the response-increasing pulse such that the magnitude of said running total 201 is reduced.

FIG. 4 shows an example of several picture pulses of a picture element 2 out of said number as a function of time. Before the application of the picture pulses, the appearance of the picture element 2 is e.g. black, denoted by B. Furthermore, the running total 201 is considered to be zero. Therefore, the time average of the first response-increasing pulse will be zero. The first response-increasing pulse is e.g. a sequence of 2 potential differences, subsequently having values 15 Volts and −15 Volts, and being applied from time t1 to time t2. Each value is e.g. applied for 10 ms. The response-increasing energy is zero, i.e. 15*0.010-15*0.010. As a result of the response-increasing pulse the ability of the particles 6 to respond to the potential difference is increased and the position of the particles 6 is substantially unchanged. Successively, the first drive pulse is present from time t3 to time t4 having a drive value of 15 Volts and an associated drive duration of 40 ms. The drive energy is 0.60 Volts*sec. As a result the appearance of the picture element 2 is dark gray, denoted by DG. The time interval between t2 and t3 is small, it may even be zero. Successively, the picture is updated. The averaging means 200 receive the first response-increasing energy, being zero, and the first drive energy of the first picture pulse, being 0.60 Volts*sec, and provide a running total 201 thereof, being 0.60 Volts*sec. The drive means 100 use the running total 201 to select the time average 203 of the second response-increasing pulse such that the magnitude of the running total 201 is reduced. In this example the energy of the second response-increasing pulse is chosen −0.02 Volts*sec. The second response-increasing pulse is e.g. a sequence of 4 potential differences, subsequently having values of −15 Volts and 14 Volts, and being applied from time t5 to time t6. Each value is e.g. applied for 10 ms. The response-increasing energy is −0.02 Volts*sec, i.e. 2*14*0.010-2*15*0.010. As a result an undesired charge accumulation in the picture element 6 is reduced.

Successively, the second drive pulse is present from time t7 to time t8 having a drive value of 15 Volts and an associated drive duration of 40 ms. The drive energy is 0.60 Volts*sec. As a result the appearance of the picture element 2 is middle gray, denoted by MG. Successively, the picture is updated again. The averaging means 200 receive the first and the second response-increasing energy and the first and the second drive energy and provide a running total 201 thereof, being 1.18 Volts*sec. The drive means 100 use the running total 201 to select the time average 203 of the third response-increasing pulse such that the magnitude of the running total 201 is reduced, etc.

In a variation on the embodiment the averaging means 200 are able to receive data representative of the response-increasing energy and the drive energy of the last picture pulse from the picture pulses preceding said response-increasing pulse, the running total being equal to the sum of the response-increasing energy and the drive energy of the last picture pulse. Furthermore, the drive means are further arranged to select a sign of the time average of the response-increasing pulse to be opposite to a sign of the running total, and the magnitude of the product of the response-increasing duration and the time average of the response-increasing pulse to be smaller or equal to the magnitude of the running total. Consider, in the example of FIG. 4, the third picture update, which follows after time t8. The averaging means 200 will now receive before the picture update only the second response-increasing energy and the second drive energy and provide a running total 201 thereof, being 0.58 Volts*sec. The drive means 100 will use this running total 201 to select the time average 203 of the third response-increasing pulse such that the magnitude of the running total 201 is reduced.

It is, furthermore, preferred if the magnitude of the product of the response-increasing duration and the time average of the response-increasing pulse is substantially equal to the magnitude of the running total. Consider, in the example of FIG. 4, the second picture update, which follows after time t4. The averaging means 200 will now receive before the picture update the first response-increasing energy and the first drive energy and provide a running total 201 thereof, being 0.60 Volts*sec. The energy of the second response-increasing pulse will be −0.60 Volts*sec. The second response-increasing pulse is e.g. a sequence of 120 potential differences, subsequently having values of −15 Volts and 14 Volts. Each value is applied for 10 ms. As a result the charging of the insulators due to the first picture pulse is substantially undone.

In another embodiment the response-increasing pulse is the sum of an AC part, having an associated time average being substantially zero, and a DC part. Examples of AC parts of the response-increasing pulse of a picture element 2 out of said number are shown as a function of time in FIGS. 5A-5C. The AC part of the response-increasing pulse being applied from time ta to time tb is e.g. a periodic function of time having a constant amplitude. Examples are a sine or cosine function or a series of e.g. 6 pulses having potential difference values of alternating polarity of plus and minus 15 Volts with each pulse having a duration of 10 ms, see FIG. 5A. Another example of an AC part is a periodic function of time having a stepwise in time decreasing amplitude. An example is e.g. a series of 6 pulses having potential difference values of 15, −15, 10, −10, 5 and −5 Volts with each pulse having a duration of 10 ms, see FIG. 5B. Another example of an AC part is a series of pairs of sub-AC pulses, the two members of each pair having potential difference values of opposite polarity and substantially equal durations, the durations of the pairs in the series being a stepwise decreasing function of the serial number of the pairs in the series. An example is e.g. a series of 6 pulses having potential difference values of 15, −15, 15, −15, 15 and −15 Volts with the pulses in the series having successive durations of 20, 20, 10, 10, 5, 5 ms, see FIG. 5C.

Examples of DC parts of the response-increasing pulse of a picture element 2 out of said number are shown as a function of time in FIG. 6. The DC part of the response-increasing pulse being applied from time ta to time tb is e.g. equal to a constant, see label a in FIG. 6, a decreasing function of time, see label b in FIG. 6, or a substantially linear decreasing function of time, see label c in FIG. 6.

In another embodiment for each picture element 2 out of said number the picture pulse comprises a reset pulse between the response-increasing pulse and the drive pulse, the reset pulse being able to bring the particles 6 into one of extreme positions, the extreme positions being positions near the electrodes 3,4, the reset pulse representing an energy being at least as large as a reference energy representing an energy to change the position of particles 6 from their present position to one of the extreme positions. It is preferred if the energy of each reset pulse is substantially larger than the reference energy. Furthermore, each reset pulse is able to bring the particles 6 into the extreme position which is closest to the position of the particles 6 for displaying the picture. Furthermore, for each picture element 2 out of said number the picture pulse comprises a further response-increasing pulse between to the reset pulse and the drive pulse. In an example, the picture pulse of a picture element 2 out of said number is shown as a function of time in FIG. 7. At time t0 the running total 201 is e.g. 0.20 Volts*sec and the appearance of the picture element is middle gray. The response-increasing pulse is e.g. a sequence of 4 potential differences, subsequently having values of −15 Volts and 14 Volts, and being applied from time t0 to time t1. Each value is e.g. applied for 10 ms. The response-increasing energy is −0.02 Volts*sec. As a result an undesired charge accumulation in the picture element 6 is reduced. Successively, the reset pulse is present from time t2 to time t3 having a value of e.g. −15 Volts and an associated duration being equal to e.g. 300 ms. As a result the appearance of the picture element 2 is black, as the energy of the reset pulse is substantially larger than the reference energy, which is e.g. about 200 ms. The time interval between t1 and t2 is small, it may even be zero. Successively, the further response-increasing pulse, being a sequence of e.g. six potential differences, subsequently having values of 15 Volts, −15 Volts, 15 Volts, −15 Volts, 15 Volts and −15 Volts, is applied from time t4 to time t5. Each value is applied for e.g. 10 msec. The time interval between t3 and t4 is small, it may even be zero. Successively, the drive pulse is present from time t6 to time t7 having a value of 15 Volts and an associated duration of 40 msec. As a result the appearance of the picture element 2 is dark gray. The time interval between t5 and t6 is small, it may even be zero.

In another embodiment the response-increasing pulses are synchronized in time, hardware shaking.

1. An electrophoretic display panel for subsequently displaying pictures comprising
a plurality of picture elements, each picture element comprising two electrodes for receiving a potential difference and charged particles being able to occupy positions between the electrodes, and
drive means being able to supply to each picture element a picture pulse, each picture pulse being a sequence of potential difference pulses and comprising
a response-increasing pulse for increasing the ability of the particles to respond to the potential difference without substantially changing the position of the particles, and
a drive pulse for bringing the particles into one of the positions for displaying the respective picture,
characterized in that,
with respect to at least a number of the picture elements, for each picture element out of said number
the display panel further comprises averaging means for providing information with respect to an accumulation of charge in the picture element, which accumulation of charge is a result from picture pulses preceding the response-increasing pulse, and
the drive means are further arranged to select, based on the information, a time average of the response-increasing pulse to reduce an undesired charge accumulation in the picture element.

2. A display panel as claimed in claim 1 characterized in that
the response-increasing pulse has a response-increasing value and an associated response-increasing duration, the product of which represents a response-increasing energy,
the drive pulse has a drive value and an associated drive duration, the product of which represents a drive energy,
the averaging means are able to receive data representative of the response-increasing energy and the drive energy of the picture pulses preceding said response-increasing pulse, and provide a running total thereof, and
the drive means are further arranged to select the time average of the response-increasing pulse such that the magnitude of said running total is reduced.

3. A display panel as claimed in claim 2 characterized in that
the averaging means are able to receive data representative of the response-increasing energy and the drive energy of the last picture pulse from the picture pulses preceding said response-increasing pulse, the running total being equal to the sum of the response-increasing energy and the drive energy of the last picture pulse, and
the drive means are further arranged to select
a sign of the time average of the response-increasing pulse to be opposite to a sign of the running total, and
the magnitude of the product of the response-increasing duration and the time average of the response-increasing pulse to be smaller or equal to the magnitude of the running total.

4. A display panel as claimed in claim 3 characterized in that the magnitude of the product of the response-increasing duration and the time average of the response-increasing pulse is substantially equal to the magnitude of the running total.

5. A display panel as claimed in claim 2 characterized in that the response-increasing pulse is the sum of an AC part, having an associated time average being substantially zero, and a DC part.

6. A display panel as claimed in claim 5 characterized in that the DC part is equal to a constant.

7. A display panel as claimed in claim 5 characterized in that a magnitude of the DC part is a decreasing function of time.

8. A display panel as claimed in claim 7 characterized in that the function is substantially linear.

9. A display panel as claimed in claim 5, characterized in that the AC part is a periodic function of time having a constant amplitude.

10. A display panel as claimed in claim 5, characterized in that the AC part is a periodic function of time having a stepwise in time decreasing amplitude.

11. A display panel as claimed in claim 5, characterized in that the AC part is a series of pairs of sub-AC pulses, the two members of each pair having potential difference values of opposite polarity and substantially equal durations, the durations of the pairs in the series being a stepwise decreasing function of the serial number of the pairs in the series.

12. A display panel as claimed in claim 1 characterized in that each picture element is one of the number of the picture elements.

13. A display device comprising the display panel as claimed in claim 1.
